(19) United States
(12) Patent Application Publication
(10) Pub. No.: US 2006/0173737 A1
(43) Pub. Date: Aug. 3, 2006

(54) Business card CD that contains an e-brochure that is simultaneously published on the internet

(76) Inventor: Wiliam Alexander Dorsey IV, Atlanta, GA (US)

Correspondence Address: MICHAEL RIES, 1747A VERMONT DRIVE, ELK GROVE, IL, 60007, US

(21) Appl. No.: 11/048,586

(22) Filed: Feb. 1, 2005

(51) Int. Cl. G07G 1/14; G06Q 30/00

(52) U.S. Cl. 705/14

(57) ABSTRACT

A computer readable medium that may be a business CD card is disclosed that contains the same information that is contained in a web or marketing site. The same information may be an E-brochure published to the Internet and placing the same e-brochure on a business card CD to produce a marketing solution.

### TECHNICAL FIELD & BACKGROUND

The present invention generally relates to the field of a business card CD and the Internet. More specifically, the present invention relates to a business card CD that contains an e-brochure that is simultaneously published on the Internet.

Business card CD marketing replaces the old approach of giving out brochures that no one reads. Also replaced is the activity of passing out business cards that people file away or distributing flyers that can't tell the whole story and wasting money on marketing that people don't pay attention to. Business card CDs energize an individuals or organizations message and provide communication like never before.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a business card CD having the same content as a web or marketing site and viewable on the Internet or locally on a computer, in accordance with one embodiment of the present invention;

FIG. 2 illustrates a drawing of a flow chart of a method of marketing, in accordance with one embodiment of the present invention;

### DETAILED DESCRIPTION OF ILLUSTRATIVE EMBODIMENTS

Embodiments of the-present invention include, but are not limited to, a business card CD and a method for marketing using an e-brochure.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

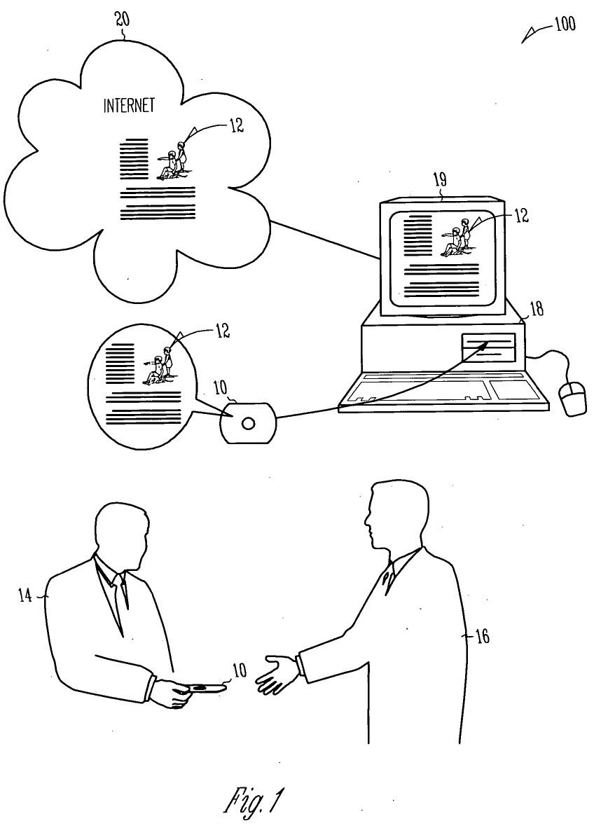

Referring now to FIG. 1, one embodiment is illustrated with a business card CD 10 having e-brochure 12. Business card CD 10 may be exchanged as a marketing solution 100 between a first party 14 and a second party 16. The first party may be a business professional, company or entity and the second party may be a customer, organization or non-profit. For example there can be an exchange between a small business owner and a potential customer, a fundraiser and a donor, a membership solicitor and potential member, a president/CEO and his board of directors, a church and its members, a human resources department and their employees, a defense contractor and the federal government, an advocacy group and their legislative contacts, a promoter and his clients, an ad agency and their sponsors, a bride and her wedding attendees, a government agency and the public, a family reunion and their attendees, a manufacturer and their distributors, a hotel and their guests, a financial service provider and their customers, equipment renters and equipment lessors, fashion designers to fashion buyers, funeral directors to families for planning, social service organizations to service recipients, book publisher to book distributors, talent scouts to musicians, instructors to students, applicant resumes for employers and many more or any relationship said in vice versa positions. It is understood that the first and second party could have any appropriate relationship that would need the marketing solution 100. Business card CD 10 may be placed in a computer 18 to show the e-brochure 12 only on a display 19 of computer 18. E-brochure 12 may be published on the Internet 20 for viewing by customer 16 on any appropriate device that shows the Internet 20.

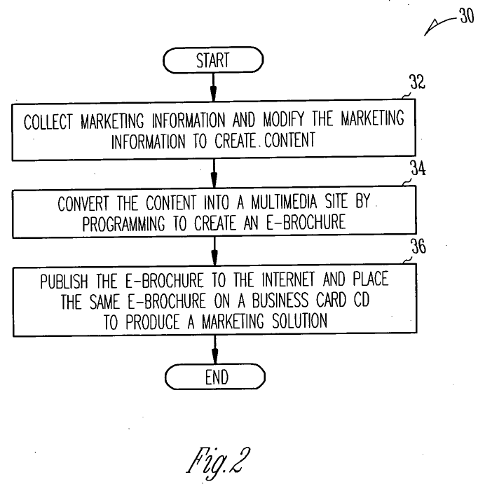

Referring to FIG. 2, illustrated is one embodiment of a method of marketing using an E-brochure 30. Provided is collecting marketing information and modifying the marketing information to create content 32. The marketing information may be modified and or repurposed by creating or editing the marketing information. The marketing information may be images, graphics, pictures, verbal information, video, music, catalogs, brochures, documents, links, email, logos, PDF files, audio marketing material and more. Shown is converting the content into a multimedia site by programming to create an e-brochure 34. The programming may be done using flash, java script, XML, HTML programming languages or scripts or any other appropriate programming software to create a multimedia site. The multimedia site may create an interactive multimedia experience that includes movement, images, music, links, user navigation, all creatively combined to entertain and educate the viewer using the e-brochure 14. Shown is publishing the E-brochure to the Internet and placing the same e-brochure on a business card CD to produce a marketing solution 36.

Provided is completing a needs assessment and analysis of existing products, approaches, processes and procedures that are presently used in conjunction with proposal design, development and distribution. Organizing orientation meetings to determine from the staff the overview, needs, opportunities and revised details of the scope. Programming meetings with key staff and personnel to determine the specific projects, their order of impact and importance. The focus will be how to leverage assets and timeframes for access to materials and information. Creative meetings that may be primarily the providers or our staff to determine overall look, feel, content placement, graphics/pictures, images, logos and other site CD card details insertion.

Research efforts to determine and assess the following: URL/Domain Research, Requested Name Search, Multiple POP Email Addresses, Unlimited Email Alias Accounts, Domain Pointer Service, and more. Designation of a liaison or Project Manager for facilitation and coordination. Deployment Project Time Line to be determined on an annual basis, with an auto renewal provision. Create multiple Internet Marketing Sites (E-brochures) that reflect a myriad of efforts being undertaken. Also may provide the capability for one main linkable site that links to all the others. Each marketing site will have some or all of the following elements: Professional Flash Web or marketing site (full color), Up to 60+ hi-impact multimedia pages, Animation and full motion home page, Multiple choices of music or customer can provide, Graphics and/or Photos of customer choice that may be 1 per page, Main title page and sub title per page, Your choice of titles and text, Internet or Email link(s), Document Conversion (.pdf), Custom graphics or Multimedia Elements, Flash image, media and text boxes, Flash intro movies, Background Image or Logo branding.

Provided is complete technical web hosting for all sites for the first year which includes server setup and account dedication. Also provided is updates and changes on a regular basis, dependent upon requirements. Provided is comprehensive site maintenance that may include repair and more for the term. Creating the Master sites in Flash, java script, XML, HTML programming languages or scripts or any other appropriate programming or programming software to create a multimedia site, with design layout options. After creating the Master sites they are converted to an Internet web or marketing site which includes web or marketing site production, editing, and coding. Once complete the Web or marketing site must be converted to executable file formats in order to be transferred to the CD, the CD may be a common CDROM, business card CD or mini CD, which also includes Mastering & Programming. The CD may be in a special shape to aid in marketing. Also, all printed documentation will be available on the Mini CD and Internet Marketing Site for supplemental review and edification. We can provide monitored access of the certain directories on the marketing sites and can control through password protection any information that needs to remain confidential. Each duplication includes; Duplicated Business Card CD that may be less than 3″ in size.

Design and layout details for a front label in full 4-colors. Provided is testing and quality control. Plastic sleeve insertion of CD in sleeve label having contact info (ie. name, phone, email etc.). An electronic file will be maintained at all times of the current content on each site for review, update and periodic assessment. Beginning assistance in a program of distributing CDs at all activities, seminars, conferences, trade shows etc. A healthy and responsive attitude will be maintained to a customer's needs and requirements, with concerns and issues being handled promptly and in a timely and professional fashion. Remember our “E-brochure” is digital, which makes it extremely flexible. Dates, data, information, product categories, etc. can be changed on a regular basis and by duplicating specific quantities per project site we never have outdated information or handout material. Technology is used to our advantage, by making information available in easy to access formats: Internet Marketing Site, Custom Cut Logo Flash Business Card CDs, Printable Site Pages, Portable Document File Storage, Animated Graphics, Live Links, Audio Sound Track and any other resource that makes the experience for the user a pleasure and not a burden.

Thus, it can be seen from the above descriptions a business card CD containing web or marketing site content have been described. While the present invention has been described in terms of the foregoing embodiments, those skilled in the art will recognize that the invention is not limited to the embodiments described. The present invention can be practiced with modification and alteration within the spirit and scope of the appended claims.

Thus, the description is to be regarded as illustrative instead of restrictive on the present invention.

What is claimed is:

1. A device comprising:
a computer-readable medium with content, the content is the same as the content on a marketing site, the marketing site is viewed over the Internet.

2. The device of claim 1, wherein the marketing site is a custom multimedia marketing site.

3. The device of claim 1, wherein the computer-readable medium is a business card CD that contains an e-brochure.

4. The device of claim 1, wherein the marketing site an e-brochure.

5. The device of claim 4, wherein the e-brochure is published on the Internet and acts as a marketing site.

6. The device of claim 1, wherein the computer-readable medium is a mini CDROM with a specific shape.

7. The device of claim 6, wherein the specific shape is a selected on of a standard business card CD, standard mini round, square, interlock, badge, shield, arrow, balloon, triangle, house, star, rectangle, flower or hex.

8. A computer implemented method comprising:
developing a marketing site with content and layout;
publishing the content and layout to the Internet in the form of a marketing site; and
placing the content and layout on a computer readable medium.

9. The method of claim 8 wherein the content and layout is simultaneously published as a marketing site and placed on the computer readable medium, the computer readable medium is a business card CD.

10. The method of claim 8, wherein the marketing site is a custom multimedia marketing site.

11. The method of claim 8, wherein the computer-readable medium is a business card CD that contains an e-brochure.

12. The method of claim 8, wherein the marketing site an e-brochure.

13. The method of claim 12, wherein the e-brochure is published on the Internet and acts as a marketing site.

14. The method of claim 8, wherein computer-readable medium is a mini CDROM with a specific shape.

15. The method of claim 14, wherein the special specific is a selected on of a standard business card CD, standard mini round, square, interlock, badge, shield, arrow, balloon, triangle, house, star, rectangle, flower or hex.

16. A method comprising:
collecting marketing information and modifying the marketing information to create content and layout;
converting the content and layout into a multimedia site by programming to create an e-brochure; and
publishing the E-brochure to the Internet and placing the same e-brochure on a computer readable medium to produce a marketing solution.

17. The method of claim 16 wherein the marketing information is modified and repurposed by creating and editing the marketing information.

18. The method of claim 16 wherein the programming is done using flash, java script, XML, HTML programming languages or scripts to create the multimedia site.

19. The method of claim 16 wherein the computer readable medium is a business card CD.
